(19) United States
(12) Patent Application Publication
(10) Pub. No.: US 2006/0136971 A1
(43) Pub. Date: Jun. 22, 2006

(54) Video distribution apparatus and program

(76) Inventors: Satoshi Uchida, Tokyo (JP); Akiyoshi Kato, Kawasaki-shi (JP); Hideki Miyazato, Yokohama-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/287,917

(22) Filed: Nov. 28, 2005

(30) Foreign Application Priority Data
Dec. 20, 2004 (JP) P2004-367458

(51) Int. Cl. H04N 7/173; H04N 7/00; H04N 11/00; H04N 7/16; H04N 7/18

(52) U.S. Cl. 725/81; 725/134; 725/142; 725/89; 348/552

(57) ABSTRACT

A video distribution apparatus that distributes video data to a plurality of machines through a network, the video distribution apparatus includes a preprogramming record unit configured to record preprogramming information setting a time zone to distribute the video data to a first machine which is one of the plurality of machines, a control unit configured to determine whether or not the video data can be distributed to the first machine before the time zone set by the preprogramming information, and a communication unit configured to notify at least one of the plurality of machines that the video data can be distributed if the control unit determines that the video data cannot be distributed to the first machine.

### CROSS REFERENCE TO RELATED APPLICATIONS

This Application is based upon and claims the benefit of priority from the prior Japanese Patent Applications No. 2004-367458, filed on Dec. 20, 2004; the entire contents of which are incorporated herein by reference.

### BACKGROUND

1. Field of the Invention

This invention relates to a video distribution apparatus for distributing video data from a TV tuner, etc., and a program for controlling the video distribution apparatus.

2. Description of the Related Art

In recent years, a system of connecting various home machines such as a TV, a refrigerator, and a PC (Personal Computer) through a network, for example, a home network, etc., has been designed. (For example, refer to JP-A-2003-219486.) JP-A-2003-219486 proposes particularly a system of connecting video signals of a TV, a video, etc. This system described in JP-A-2003-219486 is a network AV (Audio Video) transmission system as a set of an AV transmitter connected to a TV tuner, a video, etc., for sending a video signal input from any of the machines through a wireless LAN (Local Area Network) and an AV receiver for receiving the video signal in a different room in the house and outputting the video signal to a TV, a PVR (Personal Video Recorder), etc. This makes it possible to record the video of the TV tuner, etc., connected to the AV transmitter in the PVR in the different room in the house.

On the other hand, often the video resources that can be sent from a video machine are generally limited. For example, a TV tuner generally covers video signals only of one to two channels. Thus, for example, if the video signal of a TV tuner that can send the video signals only of one channel is transmitted from the AV transmitter and is recorded in a notebook PC connected to the AV receiver, the user cannot view or record the video of the TV tuner in any other machine in the same time zone.

Thus, in the system in the related art, the machine connected to the AV receiver cannot determine whether or not another machine actually receives a video signal. If setting is made so that the video signal of a TV tuner which is connected to the AV transmitter and can send the video signals only of one channel is recorded in one notebook PC connected to the AV receiver as in the example described above and the video signal cannot actually be recorded for some reason such that the notebook PC is brought out to the outside, actually the TV tuner becomes available. However, another machine has no means for providing the machine with information indicating that the TV tuner is available, and thus determines that the video from the TV tuner cannot be viewed or recorded, the effective use of the video resources cannot be made.

It is therefore an object of the invention to provide a video distribution apparatus capable of making the effective use of limited video resources.

### BRIEF DESCRIPTION OF THE DRAWINGS

In the accompanying drawings:

FIG. 1 is a drawing to show a video distribution system according to a first embodiment of the invention;

FIG. 2 is a block diagram to show the configuration of a video station according to the first embodiment of the invention;

FIG. 3 is a block diagram to show the configuration of a notebook PC according to the first embodiment of the invention;

FIG. 4 is a drawing to show the appearance of a video station remote control according to the first embodiment of the invention;

FIG. 5 is a flowchart to show a processing flow for the user to view video transmitted from the video station according to the first embodiment of the invention;

FIG. 6 is a flowchart to show a processing flow for the user to set preprogrammed recording using the video station and the notebook PC according to the first embodiment of the invention;

FIG. 7 is a drawing to show an example of a recording preprogramming registration screen of the notebook PC according to the first embodiment of the invention;

FIG. 8 is a drawing to show an example of preprogramming information of preprogrammed recording that the notebook PC according to the first embodiment of the invention has;

FIG. 9 is a drawing to show an example of preprogramming information of preprogrammed recording that the video station according to the first embodiment of the invention has;

FIG. 10 is a flowchart to show a preprogrammed recording processing flow of the video station and the notebook PC according to the first embodiment of the invention; and

FIG. 11 is a flowchart to show a preprogrammed recording processing flow of a video distribution system according to a modified example of the invention.

### DETAILED DESCRIPTION OF THE INVENTION

A video distribution apparatus of the invention will be discussed with reference to the accompanying drawings.

### First Embodiment

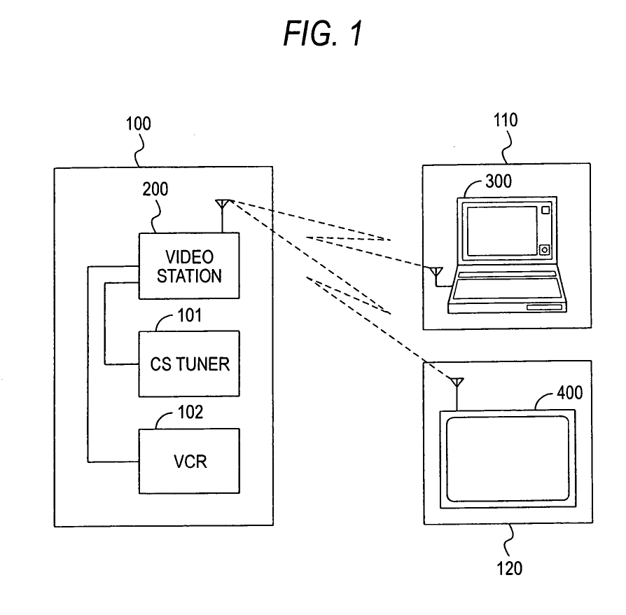

FIG. 1 is a drawing to show the configuration of a video distribution system according to an embodiment of the invention. A video station 200 is placed in a living room 100, a notebook PC 300 is placed in a private room 110, and a network TV 400 is placed in a private room 120. The video station 200 distributes videos from a terrestrial tuner included in the video station 200 and a CS tuner 101 and a VCR (Video Cassette Recorder) 102 of external machines connected to the video station 200 to the notebook PC 300 placed in the private room 110 and the network TV 400 placed in the private room 120 by wireless communications. The notebook PC 300 and the network TV 400 can display the video received from the video station 200. In addition, the notebook PC 300 and the network TV 400 include each an HDD (Hard Disk Drive) and can also record the video from the video station 200.

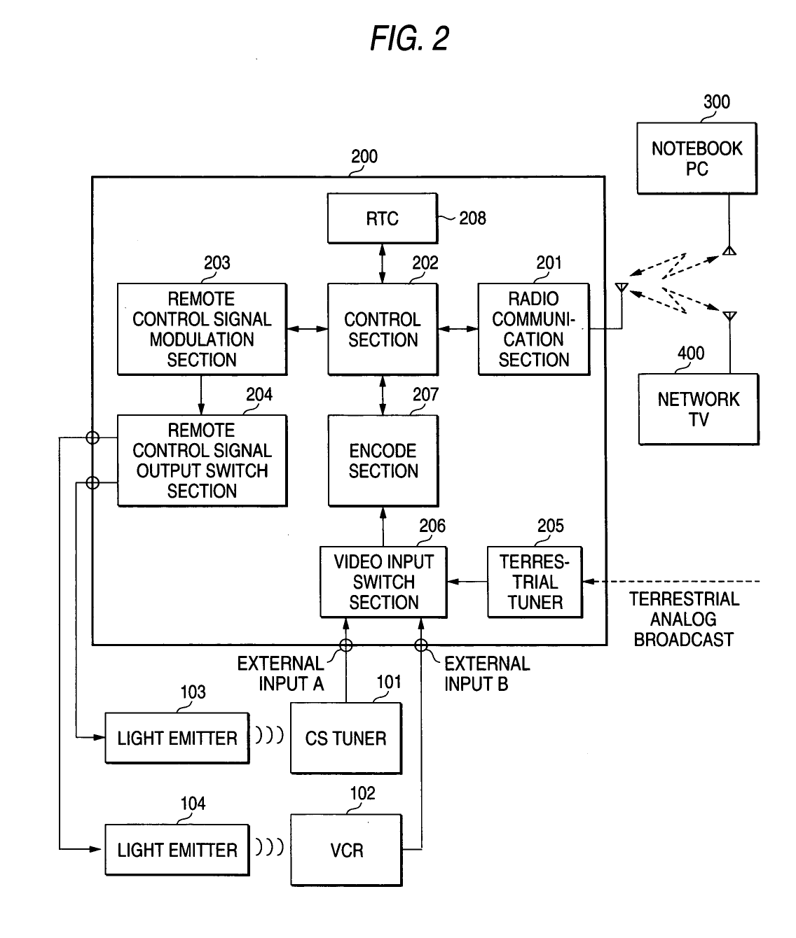

FIG. 2 is a block diagram to show the configuration of the video station 200. The video station 200 is made up of a wireless communication section 201 for conducting wireless communications with the notebook PC 300 and the network TV 400, a control section 202 for controlling the whole video station 200, a remote control signal modulation section 203 for modulating remote control signals sent from the notebook PC 300 and the network TV 400, a remote control signal output switch section 204 for switching the output direction of an output signal of the remote control signal modulation section 203 between light emitters 103 and 104, the light emitters 103 and 104 for emitting infrared control signals for controlling the CS tuner 101 and the VCR 102 respectively, a terrestrial tuner 205, a video input switch section 206 for switching video signal input to be accepted among the CS tuner 101, the VCR 102, and the terrestrial tuner 205, an encode section 207 for encoding the video signal input from the video input switch section 206, and an RTC (Real Time Clock) 208 for generating time information. The notebook PC 300 and the network TV 400 are of a similar configuration and function in a similar manner and therefore in the description to follow, communications with the notebook PC 300 are taken as an example.

The wireless communication section 201 conducts wireless communications with the notebook PC 300. More specifically, the wireless communication section 201 transmits video data to the notebook PC 300 and receives a remote control signal from the notebook PC 300. The communications are conducted according to a wireless LAN system; the communication frequency band is a 2.4-GHz band (IEEE802.11b or IEEE802.11g) or a 5-GHz band (IEEE802.11a).

The control section 202 is made up of a CPU (Central Processing Unit) and memory for controlling the whole video station 200. A program including a function of recording a recording schedule, a function of determining whether or not it is possible for the notebook PC 300 to record, a function of transmitting cancel information to the network TV 400, and the like (described later) is stored in the memory in the control section 202 and is executed by the CPU.

The remote control signal modulation section 203 modulates the remote control signal sent from the notebook PC 300 and to be sent to the CS tuner 101 or the VCR 102.

The remote control signal output switch section 204 is connected to the light emitters 103 and 104 and switches the transmission direction of the remote control signal provided by the remote control signal modulation section 203 between the light emitters 103 and 104. The light emitters 103 and 104 emit infrared remote control signals for controlling the CS tuner 101 and the VCR 102 respectively. The remote control signal emitted at this time is a remote control signal of the bit string accepting the remote control signal in the notebook PC 300.

The terrestrial tuner 205 is a tuner for receiving terrestrial analog broadcasts. It is assumed that the terrestrial tuner 205 covers output of the video signal of one channel only.

The video input switch section 206 switches video signal input among the terrestrial tuner 205, the CS tuner 101 connected to external input A, and the VCR 102 connected to external input B in response to remote control operation of the user, etc.

The encode section 207 encodes the video signal input from the video input switch section 206 to video data in MPEG2 (Moving Picture Experts Group phase 2) format.

The RTC 208 is an IC (integrated circuit) dedicated to clocking and generates time information. It receives power supply from an internal battery and operates while the power of the video station 200 is off. The RTC 208 is always adjusted to the correct time according to NTP (Network Time Protocol).

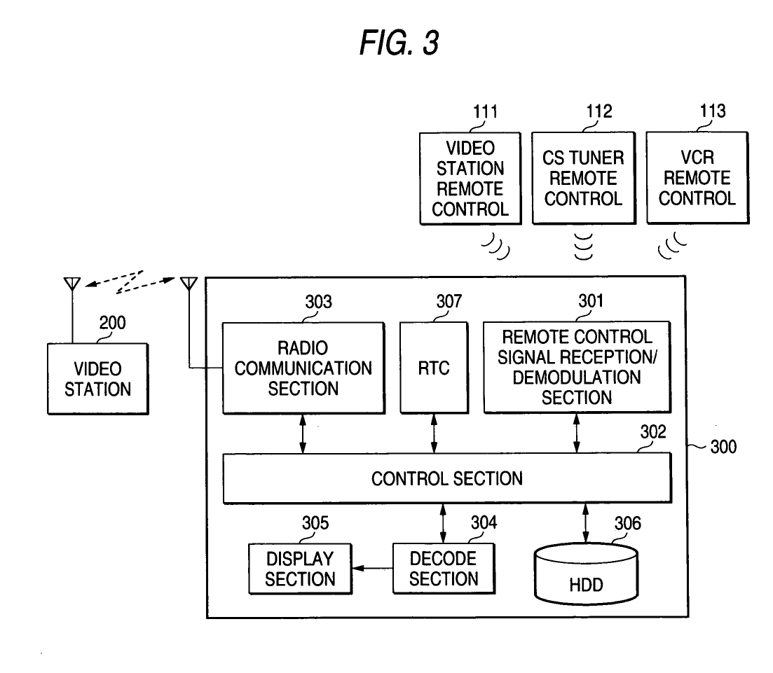

FIG. 3 is a block diagram to show the configuration of the notebook PC 300. The network TV 400 differs from the notebook PC 300 in the operation of the control section 302, etc., because they are different machines, but basically the network TV 400 has a similar configuration to that of the notebook PC 300 and therefore will not be discussed. The notebook PC 300 is made up of a remote control signal reception/demodulation section 301 for receiving and demodulating an infrared signal from a remote control to provide a remote control signal, a control section 302 for controlling the whole notebook PC 300, a wireless communication section 303 for conducting wireless communications with the video station 200, a decode section 304 for decoding video data received from the video station 200, a display section 305 for displaying the video provided by the decode section 304, an HDD (Hard Disk Drive) 306 for storing the video data received from the video station 200, and an RTC 307 for generating time information.

The remote control signal reception/demodulation section 301 receives and demodulates an infrared signal from a video station remote control 111, a CS tuner remote control 112, and a VCR remote control 113 to provide a remote control operation signal.

The control section 302 is made up of a CPU and memory for controlling the whole notebook PC 300.

The wireless communication section 303 conducts wireless communications with the video station 200. More specifically, the wireless communication section 303 transmits a remote control operation signal to the video station 200 and receives video data from the video station 200. Of course, the communications are conducted according to the same wireless LAN system as the video station 200; the communication frequency band to be used is a 2.4-GHz band (IEEE802.11b or IEEE802.11g) or a 5-GHz band (IEEE802.11a).

The decode section 304 decodes video data in MPEG format received from the video station 200.

The display section 305 displays the video provided by decoding the video data received in the wireless communication section 303 by the decode section 304.

The HDD 306 stores the video data received in the wireless communication section 303. The stored video data is decoded by the decode section 304 at the playback time for display on the display section 305.

The RTC 307 is an IC dedicated to clocking and generates time information. It receives power supply from an internal battery and operates while the power of the notebook PC 300 is off. The RTC 208 is always adjusted to the correct time according to NTP.

The user transmits a signal to the notebook PC 300 through the video station remote control 111, the CS tuner remote control 112, or the VCR remote control 113 for controlling the corresponding machine, as described above.

The CS tuner remote control 112 and the VCR remote control 113 are usual remote controls attached to the CS tuner 101 and the VCR 102 respectively. Similar control can be performed regardless of whether a signal from the remote control (112, 113) is emitted toward the corresponding machine (CS tuner 101, VCR 102) or the notebook PC 300. In the notebook PC 300, if the remote control signal is a remote control signal from any other than the video station remote control 111, the signal with the received bit string held is transmitted from the wireless communication section 303 to the video station 200. If the video station 200 receives an operation signal of a bit string from the wireless communication section 201, the light emitters 103 and 104 are caused to emit light with the bit string held and thus if a remote control signal is sent to the notebook PC 300, the CS tuner 101 and the VCR 102 can be operated.

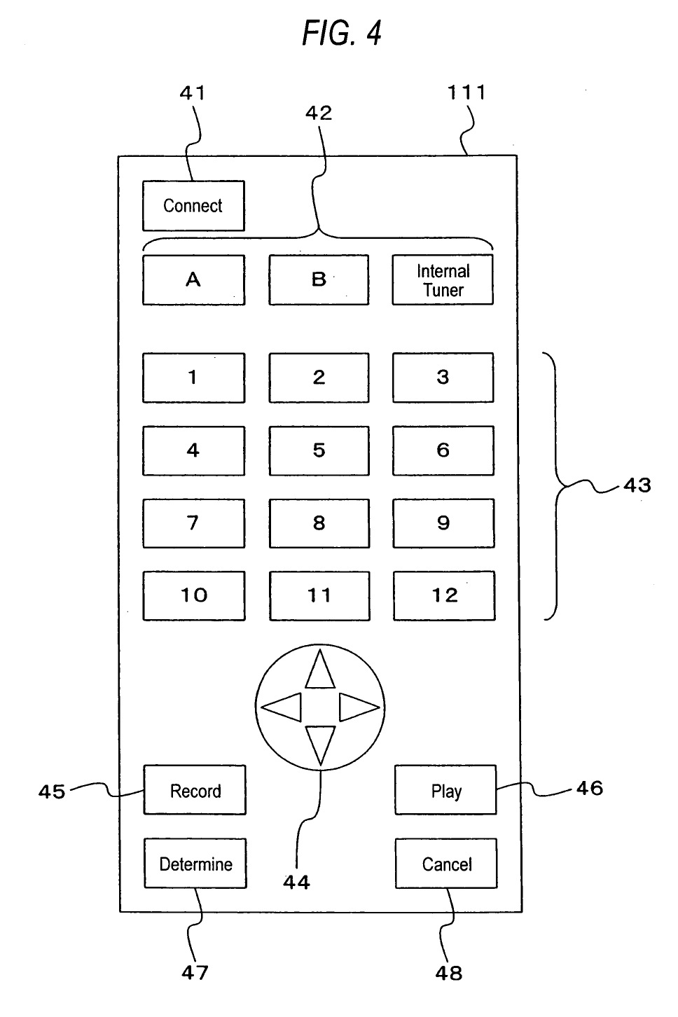

The video station remote control 111 is a remote control for controlling the video station 200. FIG. 4 is a drawing to show the appearance of the video station remote control 111. The video station remote control 111 includes a connect button 41 for establishing connection between the video station 200 and the notebook PC 300, video input switch buttons 42 for switching a video input machine, channel buttons 43, a select key 44 for moving a cursor displayed on a screen and changing the numeric value, a record button 45, a play button 46, a determine button 47, and a cancel button 48.

The connect button 41 is a button for establishing connection between the video station 200 and the notebook PC 300. If the connection of the video station 200 and the notebook PC 300 is not established, video cannot be displayed on the notebook PC 300. If the CS tuner remote control 112 or the VCR remote control 113 is used for the notebook PC 300, unless the connection of the video station 200 and the notebook PC 300 is established, the CS tuner 101 or the VCR 102 cannot be controlled.

The video input switch buttons 42 are buttons for selecting the video signal input machine. As any of the buttons is operated, the video input switch section 206 of the video station 200 can be switched. For example, if button A is pressed, the video input signal from the CS tuner 101 connected to the external input A of the video station 200 is accepted; if button B is pressed, the video input signal from the VCR 102 connected to the external input B of the video station 200 is accepted; if an internal tuner button is pressed, the video input signal from the terrestrial tuner 205 of the video station 200 is accepted.

The channel buttons 43 are buttons for switching a channel of the terrestrial tuner 205. Numerals 1 to 12 are assigned to the channel buttons 43 as channel numbers.

The select key 44 provides buttons for moving the cursor displayed on the screen of the notebook PC 300 and changing the numeric value on the screen. The upper, lower, left, and right buttons of the select key 44 can be pressed as desired.

The record button 45 is a button pressed by the user to program the notebook PC 300 to record video.

The play button 46 is a button pressed by the user to play back the video data transmitted from the video station 200 and recorded and stored in the HDD 306 of the notebook PC 300.

The determine button 47 is a button pressed by the user to determine the item displayed on the notebook PC 300.

The cancel button 48 is a button pressed by the user to cancel the item displayed on the notebook PC 300.

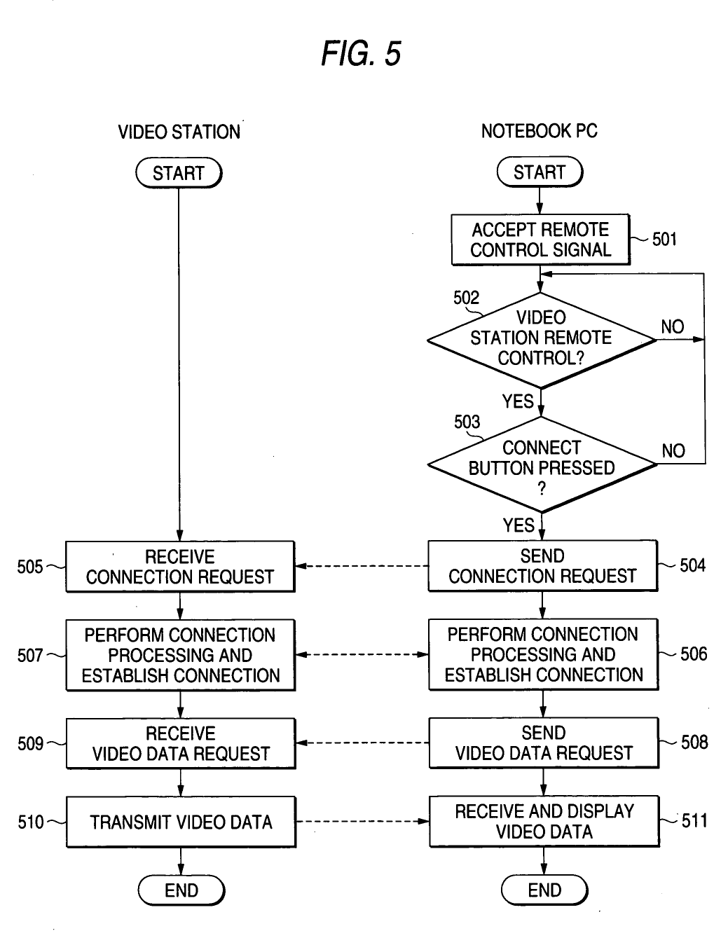

FIG. 5 is a flowchart to show a processing flow of the video station 200 and the notebook PC 300 for the user to start viewing video transmitted from the video station 200 at the notebook PC 300. It is assumed that connection between the video station 200 and the notebook PC 300 is not established when the processing is started.

To begin with, the notebook PC 300 accepts a remote control operation signal generated by remote control operation of the user from the remote control signal reception/demodulation section 301 (step 501). Further, the control section 302 determines whether or not the input remote control signal is a remote control signal input from the video station remote control 111 (step 502). The input remote control signal is demodulated in the remote control signal reception/demodulation section 301 and if the signal can be interpreted in the notebook PC 300, it can be determined that the input remote control signal is input from the video station remote control 111; if the signal cannot be interpreted, it can be determined that the input remote control signal is input from any other remote control. If the input remote control signal is not input from the video station remote control 111, no processing is performed and the notebook PC 300 waits for input of a new remote control signal (step 501).

If the input remote control signal is input from the video station remote control 111, the control section 302 determines whether or not the input remote control signal is a signal generated as the user presses the connect button 41 (step 503). If the signal is a signal generated as the user presses any button other than the connect button 41, no processing is performed and the notebook PC 300 waits for input of a new remote control signal (step 501).

If the signal is a signal generated as the user presses the connect button 41, connection processing between the notebook PC 300 and the video station 200 is entered. Specifically, first the notebook PC 300 sends a connection request from the wireless communication section 303 to the video station 200 (step 504). The video station 200 receives the connection request at the wireless communication section 201 (step 505) and the notebook PC 300 and the video station 200 perform connection processing and establish machine connection in the wireless communication section 201 and the wireless communication section 303 (steps 506 and 507).

After the connection is established, the notebook PC 300 sends a video data request from the wireless communication section 303 to the video station 200 (step 508). It is assumed that the video data requested at this time is the video data of the machine and channel corresponding to the previously viewed program. For example, if the user turned off the power of the notebook PC 300 viewing terrestrial TV channel 1 at the preceding time, the notebook PC 300 requests the video station 200 to send video data of terrestrial TV channel 1.

The video station 200 receives the video data request from the notebook PC 300 in the wireless communication section 201 (step 509) and switches the input machine (the internal terrestrial tuner 205, the CS tuner 101, or the VCR 102) in the video input switch section 206 in response to the request and transmits appropriate video data from the wireless communication section 201 to the notebook PC 300 (step 510).

The notebook PC 300 receives the video data from the video station 200 at the wireless communication section 303 and displays the video data on the display section 305 (step 511).

If the viewer wants to switch the input machine after starting to view, he or she may press any of the video input switch buttons 42 of the video station remote control 111. For example, when the viewer wants to view video output from the VCR 102, if he or she presses the B button of the video input switch buttons 42, the signal is received through the remote control signal reception/demodulation section 301 of the notebook PC 300. The code based on the signal is transmitted from the wireless communication section 303 to the video station 200 under the control of the control section 302, and the video station 200 receives the code through the wireless communication section 201. Upon reception of the code, the video station 200 switches the machine accepting the input of the video input switch section 206 to the external input B. Accordingly, the video signal from the VCR 102 connected to the external input B is input to the video station 200 and is encoded in the encode section 207 and then is sent from the wireless communication section 201 to the notebook PC 300. The notebook PC 300 receives the video data through the wireless communication section 303 and decodes the video data by the decode section 304 and displays video on the display section 305.

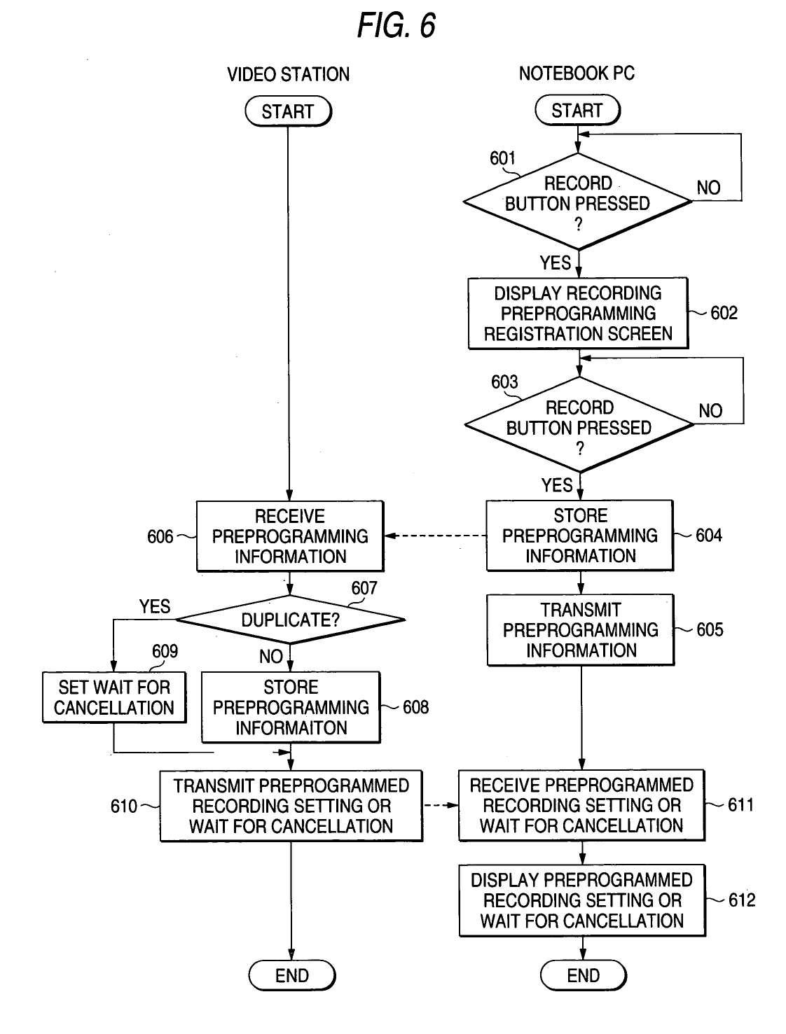

Next, preprogrammed recording will be discussed. FIG. 6 is a flowchart to show a processing flow of the video station 200 and the notebook PC 300 for the user to set preprogrammed recording.

To begin with, the control section 302 determines whether or not a signal generated as the user presses the record button 45 of the video station remote control 111 is received through the remote control signal reception/demodulation section 301 (step 601). If a remote control signal generated as the user presses the record button 45 is not received, the notebook PC 300 waits until the remote control signal is received.

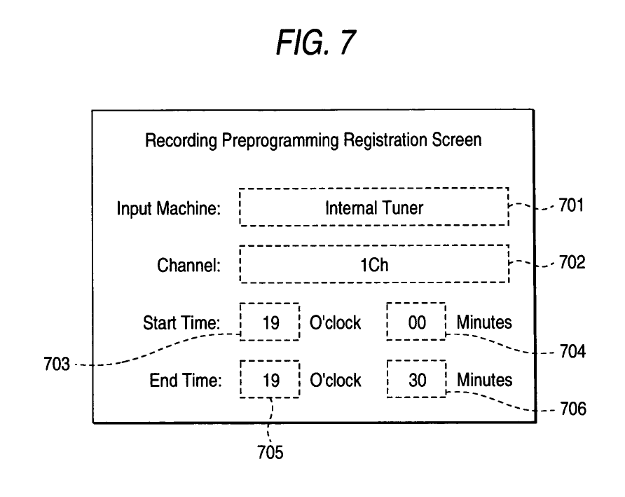

Upon reception of the remote control signal generated as the user presses the record button 45, the control section 302 displays a recording preprogramming registration screen on the display section 305 (step 602). FIG. 7 shows an example of the recording preprogramming registration screen for the user to set preprogrammed recording.

The recording preprogramming registration screen displays six windows of an input machine window 701, a channel window 702, a start time (hours) window 703, a start time (minutes) window 704, an end time (hours) window 705, and an end time (minutes) window 706. To select any of the items, the user presses the upper button or the lower button of the select key 44 of the video station remote control 111.

The machine for transmitting the video data to be recorded is set in the input machine window 701. The user can select any from among items of “internal tuner,” “external input A,” and “external input B.” The items “internal tuner,” “external input A,” and “external input B” indicate the internal terrestrial tuner 205, the CS tuner 101 connected to the external input A, and the VCR 102 connected to the external input B respectively. The user can display or switch each item by pressing the right button or the left button of the select key 44 and can determine the selected item by pressing the determine button 47.

A channel of the internal tuner is entered in the channel window 702. The user moves up or down the channel number by pressing the right button or the left button of the select key 44 to show any desired channel number, and can determine the channel number by pressing the determine button 47.

The user can set hours of the record start time, minutes of the record start time, hours of the record end time, and minutes of the record end time in the start time (hours) window 703, the start time (minutes) window 704, the end time (hours) window 705, and the end time (minutes) window 706 respectively. The user moves up or down the numeric value by pressing the right button or the left button of the select key 44 to show any desired numeric value, and can determine the numeric value by pressing the determine button 47.

If the user thus completes all settings and presses the record button 45, the settings are registered. Referring again to FIG. 6, the notebook PC 300 determines in the control section 302 whether or not a remote control signal generated as the user presses the record button 45 is received through the remote control signal reception/demodulation section 301, namely, the user completes setting the preprogrammed recording (step 603). If a remote control signal generated as the user presses the record button 45 is not received, the notebook PC 300 waits until the remote control signal is received.

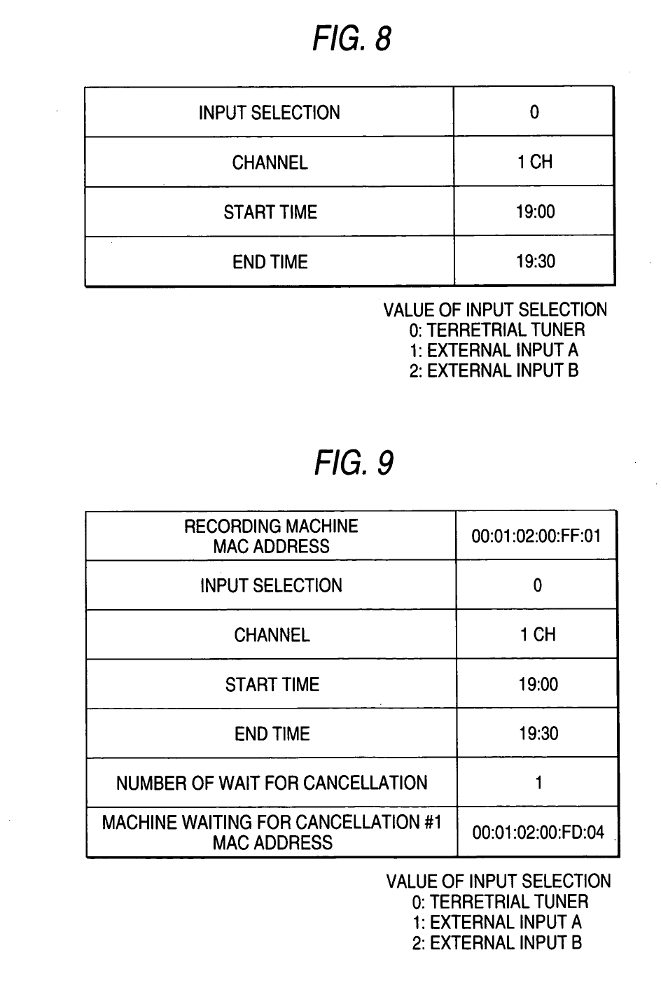

Upon reception of the remote control signal generated as the user presses the record button 45, the setup preprogramming information is stored in memory of the control section 302 (step 604). FIG. 8 is a drawing to show an example of the preprogramming information stored in the control section 302. In the example in FIG. 8, the video input machine (terrestrial tuner), the channel (channel 1), the start time (19 hours 00 minutes), and the end time (19 hours 30 minutes) are stored in the memory of the control section 302 as the preprogramming information.

While the preprogramming information is stored in the memory, the preprogramming information is transmitted from the wireless communication section 303 to the video station 200 (step 605). The video station 200 receives the preprogramming information through the wireless communication section 201 (step 606) and compares the preprogramming information with another piece of preprogramming information stored in memory of the control section 202 to determine whether or not recording is duplicately preprogrammed (step 607). To make this determination, the record start time and end time and the number of video resources that can be output from the setup input machine are referenced. For example, the terrestrial tuner 205 can output the video signal of one channel only and thus whether or not recording is duplicately preprogrammed can be determined based on whether or not another preprogrammed recording using the terrestrial tuner is set from 19 hours 00 minutes to 19 hours 30 minutes.

If preprogrammed recording is not duplicately set (NO at step 607), the preprogramming information is stored in the memory of the control section 202. FIG. 9 is a drawing to show an example of the preprogramming information stored in the memory of the control section 202. In the example in FIG. 9, wait for cancellation is set through the network TV 400 after recording preprogramming through the notebook PC 300 (preprogramming information in FIG. 7+MAC address of notebook PC).

If preprogrammed recording setting entered through the notebook PC 300 is duplicate with another (YES at step 607), wait for cancellation is set in the duplicate preprogramming information (step 609). The wait for cancellation will be discussed with reference to FIG. 9. FIG. 9 shows an example of preprogramming information stored in the memory of the control section 202 if a request for duplicate recording preprogramming is entered through the network TV 400 after recording preprogramming is set through the notebook PC 300. If a request for setting duplicate recording preprogramming is entered, the number of waits for cancellation is incremented by one (in the example in FIG. 9, to 1) and an item of the MAC address of the machine waiting for cancellation (in the example, the network TV 400) is added. Accordingly, if the recording preprogramming is canceled, it is made possible to transmit information to the recording machine waiting for cancellation.

After preprogrammed recording is set (step 608) or after wait for cancellation is set (step 609), information to the effect that preprogrammed recording is set or that wait for cancellation is set is transmitted from the wireless communication section 201 to the notebook PC 300. After the information is received at the wireless communication section 303 (step 611), the control section 302 of the notebook PC 300 displays a message to the effect that preprogrammed recording is set or that wait for cancellation is set on the display section 305 (step 612).

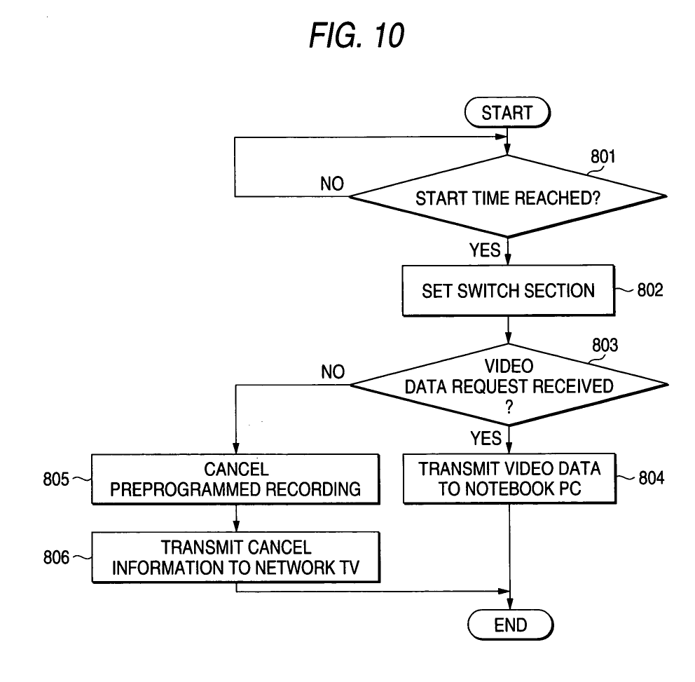

Subsequently, a recording preprogramming processing flow of the video station 200 and the notebook PC 300 will be discussed. FIG. 10 is a flowchart to show the recording preprogramming processing flow of the video station 200 and the notebook PC 300.

The video station 200 makes a comparison between the recording start time of the preprogramming information stored in the memory of the control section 202 and the time of the RTC 208 and determines whether or not the start time comes by the control section 202 (step 801). If the start time does not come, the video station 200 waits until the start time comes.

If the start time comes, the video input switch section 206 switches the video input machine (the terrestrial tuner 205, the CS tuner 101, or the VCR 102) in response to the input selection value of the preprogramming information. In the example in FIG. 9, if the time of 19 hours 00 minutes is reached (or a given time before 19 hours 00 minutes is reached), the video input switch section 206 switches the video input machine to the terrestrial tuner 205 and set the channel to channel 1.

Next, the control section 202 determines whether or not a request for transmitting video data is received through the wireless communication section 201 from the notebook PC 300 (step 803). If a request for transmitting video data is received (YES at step 803), sending the video data involved in the preprogrammed recording from the wireless communication section 201 is started,

If the wireless communication section 201 does not receive a request for transmitting video data from the notebook PC 300 although the start time is reached (NO at step 803), it is determined that the notebook PC 300 cannot record for some reason such that the notebook PC 300 is brought out to the outside, and the recording preprogramming is canceled (step 805). In addition, cancel information is transmitted to the machine waiting for cancellation (step 806). In the example in FIG. 9, the network TV 400 waits for cancellation in the corresponding time zone and therefore the available video resource (in the example in FIG. 9, the terrestrial tuner) and the time zone (in the example in FIG. 9, 19 hours 00 minutes to 19 hours 30 minutes) are transmitted to the network TV 400.

If the network TV 400 makes a request for transmitting video data upon reception of the cancel information, the video station 200 starts to transmit video data through the wireless communication section 201, so that the video data can be viewed and/or recorded.

As described above, according to the embodiment, if a request for transmitting video data is not received from the notebook PC 300 although the recording start time is reached, preprogrammed recording cancel information is transmitted to the network TV 400. Accordingly, it is made possible to use the terrestrial tuner 205 (available video resource) in the record time zone.

In the embodiment, the preprogramming information in the video station 200 previously involves information concerning wait for cancellation, so that cancel information can be transmitted only to the machine waiting for cancellation and the network traffic can be decreased.

The video input machine is not limited to the CS tuner 101 or the VCR 102 and may be a DVD (digital versatile disk) player, an HDD recorder, etc. The number of the video input machines is not limited to two; for example, an embodiment wherein only the internal terrestrial tuner 205 is included and no external input machine is included is also possible.

Further, the video display machine is not limited to the notebook PC 300 or the network TV 400 and may be a PC, a mobile telephone, a PDA (Personal Digital Assistant), etc., if the machine includes a display section. The number of the video display machines is not limited to two. Alternatively, the display may be connected to the outside. Record media in the notebook PC 300 may be not only hard disk, but also other record media such as video tape and writable DVD.

Particularly, if three or more video display machines are included, two or more machines may wait for cancellation, of course. Thus, if the machines waiting for cancellation are assigned priority and cancel information is transmitted according to the priority, applying duplicate machines to be used after waiting for cancellation can be suppressed.

The preprogramming information in the video station 200 need not necessarily involve information concerning wait for cancellation (the number of waits for cancellation and the MAC address of each machine waiting for cancellation). If a request for transmitting video data is not received although the recording start time is reached, cancel information (available video resource and time zone) is broadcast to all connected machines.

In the embodiment, if preprogrammed recording is duplicate, automatically wait for cancellation is set, but information indicating that preprogrammed recording is duplicate may be once transmitted to the notebook PC 300 for the user to determine whether or not to set wait for cancellation. In doing so, an increase in the number of unnecessary waits for cancellation can be suppressed.

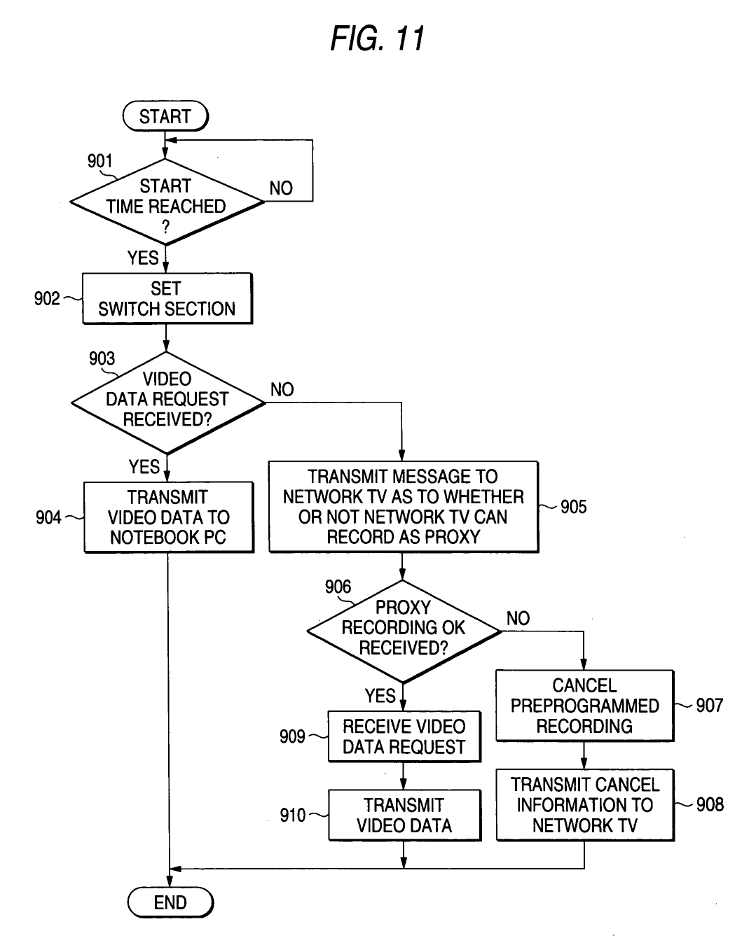

If the notebook PC 300 cannot record for some reason such that the notebook PC 300 is brought out to the outside, it is also possible to cause another machine to record instead of the notebook PC 300. FIG. 11 shows a processing flow of the video station 200 for enabling the network TV 400 to be requested to record instead of the notebook PC 300 according to the recording preprogramming set in the notebook PC 300. Steps 901 to 904 are similar to steps 801 to 804 in FIG. 10 and therefore will not be discussed again.

If a request for transmitting video data cannot be received at the wireless communication section 201 although the recording start time is reached (NO at step 903), the video station 200 transmits a message to the network TV 400 as to whether or not the network TV 400 can record as a proxy (step 905). The information sent at this time includes the recording start time, the recording end time, etc. If a response meaning that proxy recording is possible cannot be received from the network TV 400 (NO at step 906), the recording preprogramming is canceled (step 907) and cancel information is transmitted to the network TV 400 (step 908) as at steps 805 and 806 in FIG. 10.

If a response meaning that proxy recording is possible is received from the network TV 400 (YES at step 906), a request for transmitting video data is accepted from the network TV 400 (step 909) and then the video data is transmitted to the network TV 400 (step 910).

What is claimed is:

1. A video distribution apparatus that distributes video data to a plurality of machines through a network, the video distribution apparatus comprising:
a preprogramming record unit configured to record preprogramming information setting a time zone to distribute the video data to a first machine which is one of the plurality of machines;
a control unit configured to determine whether or not the video data can be distributed to the first machine before the time zone set by the preprogramming information; and
a communication unit configured to notify at least one of the plurality of machines that the video data can be distributed if the control unit determines that the video data cannot be distributed to the first machine.

2. The video distribution apparatus as claimed in claim 1,
wherein if data is received from the first machine before the time zone, the control unit determines that the video data can be distributed, and
if data is not received from the first machine before the time zone, the control unit determines that the video data cannot be distributed.

3. The video distribution apparatus as claimed in claim 1,
wherein the preprogramming record unit records cancellation wait information concerning a second machine other than the first machine to which the video data is to be distributed if the video data cannot be distributed to the first machine in the time zone, and
if the control unit determines that the video data cannot be distributed to the first machine in the time zone, the communication unit notifies the second machine that the video data can be distributed based on the cancellation wait information.

4. The video distribution apparatus as claimed in claim 1,
wherein the preprogramming record unit records cancellation wait information concerning a plurality of machines which wait for cancellation and to which the video data is to be transmitted and concerning a priority of the plurality of machines, if the video data cannot be distributed to the first machine in the time zone, and
if the control unit determines that the video data cannot be transmitted to the first machine in the time zone, the communication unit notifies the machine waiting for cancellation that the video data can be distributed according to the priority.

5. A video distribution apparatus that distributes video data to a plurality of recording machines through a network, the video distribution apparatus comprising:
a preprogramming record unit configured to record preprogramming information setting a time zone to distribute the video data to a first recording machine which is one of the plurality of recording machines;
a control unit configured to determine whether or not the video data can be distributed to the first recording machine before the time zone set by the preprogramming information; and
a communication unit configured to request at least one of the plurality of recording machines to record the video data based on the preprogramming information if the control unit determines that the video data cannot be distributed to the first recording machine.

6. A program for causing a computer to control a video distribution apparatus for distributing video data to a plurality of machines through a network, the program comprising:
a preprogramming record function for recording preprogramming information setting a time zone to distribute the video data to a first machine which is one of the plurality of machines;
a distribution enable/disable determination function for determining whether or not the video data can be distributed to the first machine before the time zone set by the preprogramming information; and
a notification function for notifying at least one of the plurality of machines that the video data can be distributed if the distribution enable/disable determination function determines that the video data cannot be distributed to the first machine.

7. The program as claimed in claim 6,
wherein if data is received from the first machine before the time zone, the distribution enable/disable determination function determines that the video data can be distributed, and
if data is not received from the first machine before the time zone, the distribution enable/disable determination function determines that the video data cannot be distributed.
